(19) United States
(12) Patent Application Publication
(10) Pub. No.: US 2017/0316593 A1
(43) Pub. Date: Nov. 2, 2017

(54) STRONGLY TYPED CARDS FOR POWERAPPS

(71) Applicant: Microsoft Technology Licensing, LLC, Redmond, WA (US)

(72) Inventors: Muralidhar Sathsahayaraman, Bothell, WA (US); Srideepa Banerjee, Kirkland, WA (US); Gregory S. Lindhorst, Seattle, WA (US); Radu Gruian, Sammamish, WA (US)

(21) Appl. No.: 15/199,639

(22) Filed: Jun. 30, 2016

Related U.S. Application Data
(60) Provisional application No. 62/329,107, filed on Apr. 28, 2016.

(51) Int. Cl. G06T 11/60

(52) U.S. Cl. CPC G06T 11/60

(57) ABSTRACT

Displaying data of a particular data type. A set of data to visualize is identified. Once the set of data is identified, a general type of data associated with the identified set of data is determined. Then based at least upon the determined general type of data, a specific type of data associated with the set of data is determined. Determining the specific type of data also comprises identifying a plurality of visualizations associated with the specific type of data. A visualization from the plurality of visualizations is then selected to thereby present the set of data.

### CROSS-REFERENCE TO RELATED APPLICATION

This application claims the benefit of U.S. Provisional Patent Application Ser. No. 62/329,107 filed Apr. 28, 2016, which provisional patent application is incorporated herein by reference in its entirety.

### BACKGROUND

Software programs, or applications, enable computer systems to obtain a high degree of functionality. Through the use of mobile computers, phones, and tablets, software applications have become an integral part of the way many individuals live and work. Software applications consist of computer-executable instructions that have been developed by one or more individuals and/or computer systems. For an individual to acquire the necessary skill and experience to create complex software development, has generally required years of education and experience.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to selecting a visualization for displaying data of a particular data type. For example, embodiments may include identifying a set of data to visualize. Once the set of data is identified, a general type of data associated with the identified set of data is determined. Based at least upon the determined general type of data, a specific type of data associated with the set of data is then determined. Determining the specific type of data also comprises identifying a plurality of visualizations associated with the specific type of data. A visualization from the plurality of visualizations is then selected to thereby present the set of data.

Accordingly, the most suitable visualizations may be displayed based on a determined general and specific data type. User-specific data may also be utilized to display the most intuitive visualization for a particular data set. Furthermore, a particular visualization may be manipulated by an author or end user of an application even after the particular visualization has been selected, thus providing great flexibility.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may be employed.

FIG. 2 illustrates a flowchart for the type of factors considered in selecting a visualization.

FIG. 3 illustrates a more specific flowchart focusing on factors associated with a particular data set.

FIG. 4 illustrates a more specific flowchart focusing on factors associated with an author or user of an application.

FIG. 5 illustrates a flowchart of a method for selecting a visualization for displaying data of a particular data type.

### DETAILED DESCRIPTION

At least some embodiments described herein relate to selecting a visualization for displaying data of a particular data type. For example, embodiments may include identifying a set of data to visualize. Once the set of data is identified, a general type of data associated with the identified set of data is determined. Then based at least upon the determined general type of data, a specific type of data associated with the set of data is determined. Determining the specific type of data also comprises identifying a plurality of visualizations associated with the specific type of data. A visualization from the plurality of visualizations is then selected to thereby present the set of data.

Accordingly, the most suitable visualizations may be displayed based on a determined general and specific data type. User-specific data may also be utilized to display the most intuitive visualization for a particular data set. Furthermore, a particular visualization may be manipulated by an author or end user of an application even after the particular visualization has been selected, thus providing great flexibility.

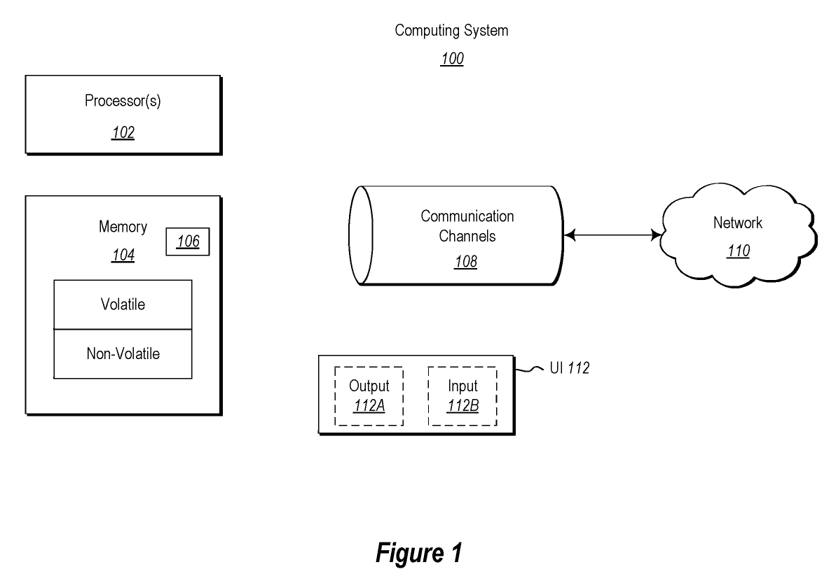

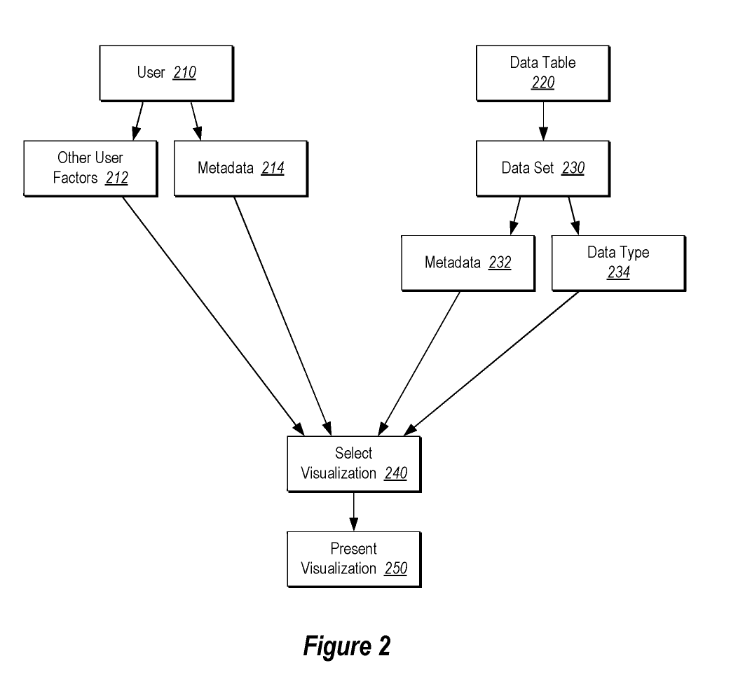

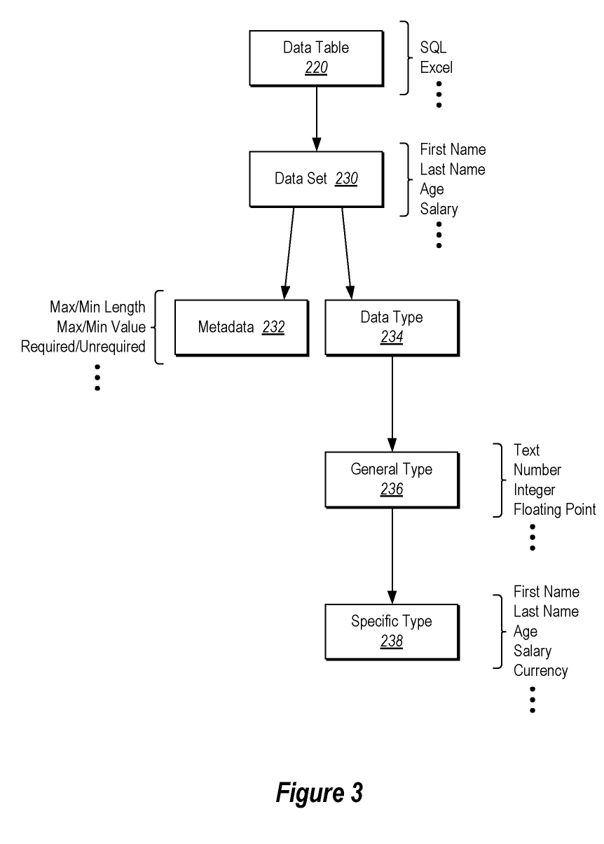

Because the principles described herein operate in the context of a computing system and a transformation chain, a computing system with respect to FIG. 1, as well as a transformation chain will first be described as enabling technologies for the principles described herein. Thereafter, further details regarding selecting a visualization with which to present data based on a variety of factors, including an identified data type, will be described with respect to FIGS. 2 through 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

The computing system 100 has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “controller”, “validator”, “runner”, “deployer”, “virtual machine”, “hypervisor” or the like, may also be used. As used in this description and in the case, these terms (regardless of whether the term is modified with one or more modifiers) are also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms, virtual reality, and so forth. Examples of input mechanisms 112B might include, for instance, microphones, touchscreens, holograms, virtual reality, cameras, keyboards, mouse of other pointer input, sensors of any type, and so forth. In accordance with the principles describe herein, alerts (whether visual, audible and/or tactile) may be presented via the output mechanism 112A.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Similarly, the principles described herein relate specifically to a foundational computer application (the “foundational application”) that enables individuals with little, or no, software development experience (i.e., a “non-developer”) to create a computer application (the “generated application”). The foundational application may further allow a non-developer to create applications that can visualize data/data sets in the most suitable/intuitive ways based on the type of data being used.

Both the foundational application and generated application may execute within the above described computer system 100. Furthermore, any generated application may model a declarative transformation graph. As such, the principles described herein may operate using a transformation chain or graph (which terms are used interchangeably herein). A transformation chain is an interconnected set of nodes that each may represent data sources or data targets. There are links between the nodes, each link representing a transformation. For any given link, the associated transformation receives copies of values of one or more data sources situated at an input end to the link, and generates resulting values being provided at one or more data targets located at the output end of the link. For any given transformation, when a value at one or more of the data sources at its input end changes, the transformation is automatically reevaluated, potentially resulting in changes in value(s) of one or more data targets at the output end of the transformation. The role of nodes and links may of course reverse, with nodes representing data flows, and links representing transformations.

In one embodiment, regardless of how complex the transformation chain is, the transformations may be constructed from declarative statements expressing equations, rules, constraints, simulations, or any other transformation type that may receive one or more values as input and provide the resulting one or more values as output. Transformation chains may be augmented as a program is built by linking different transformation chains to honor the dependencies between the chains. Portions of transformation chains may also be delegated to other devices and/or users. Nodes of the transformation graph may encapsulate specific data included within a given data set/data table (e.g., data included within a data field of a data table), which data may be visualized in a generated application, as described herein.

For example, suppose a generated application relates to managing employees within a company and visualizes at least portions of a data table that includes information relating to each employee of the company. As such, fields of the employee data table may include information such as a social security number, first name, last name, salary information, and so forth. Each field that is to be displayed within the generated application may be assigned an associated visualization, or card. A card may be made of smaller building blocks that constitute various visualization code that contribute to the overall form of the generated application. For instance, the card may comprise a text box displaying a name, a label associated with the displayed name for communicating to an end user that the text box is associated with a first name, and an error label that deals with errors that occur (e.g., when the user attempts to enter a first name with an incorrect format, the error label may be able to surface errors back to the end user).

In another example, a number may be piped into a card that uses a label that solely displays the numeric format (e.g., 1, 2, 3), into a card that visualizes the number as a position on a slider within a specific range, or into a card that visualizes the number as a point or dot in either a two or three dimensional space. As such, a given field (or fields) may be displayed within the generated application by a visual representation of the underlying data (e.g., text boxes for rendering a first name, a slider for specifying a range of salaries/income, an image for displaying a picture of an employee, and so forth). As described with respect to FIGS. 2 through 4, the computer system may use various factors in order to determine the most suitable type of card to display a given data set (e.g., the card that will be most intuitive to an author/end user, the card that will be most easily consumed by an author/end user, and so forth).

FIG. 2 illustrates the type of factors that may be analyzed by computer system 100 in order to determine/select the most suitable/intuitive cards/visualizations for presenting data that is included within the transformation chain (and ultimately, the generated application). With respect to the determination of the most suitable card for given data, there may be two separate time periods in which the determination may occur, as described more fully herein. The first time period may be during execution of the foundational application/authoring of the generated application. Thus, the principles described herein may relate to determining/selecting a card for presenting given data during the authoring of a generated application (i.e., during execution of the foundational application—“foundational application runtime”). The second time period may be after the generated application has been published, and potentially shared with others (i.e., “generated application runtime”). Thus, the principles described herein may also relate to determining/selecting a suitable card for presenting given data during execution of a published generated application.

As shown in FIG. 2, the computer system may consider both data table 220 (i.e., the data ultimately encapsulated in nodes of the transformation chain and subsequently visualized in the generated application), as well as user-specific data 210 (i.e., data associated with an author of the generated application or an end-user of the generated application, as described herein) as factors to determine the most suitable visualization to present given data. Data table 220 may comprise any type of data that can be accessed by the computer system 100, the foundational application and/or the generated application (e.g., databases, data tables, data sets included in a database/data table, a data field included in a database/data table, and so forth). For example, data table 220 may comprise a SQL table, a MICROSOFT EXCEL® table, a SHAREPOINT® list, and so forth.

With respect to data 220, the computer system 100 may consider a given data set 230 (e.g., particular data within data table 220 that has been selected by a user to be included in a generated application), as well as the shape of the data set. In the continuing employee example, the shape of the data set may comprise details associated with any given employee included within the employee data table, including first name, last name, age, social security number, compensation, birthday, start date of employment, benefits, and so forth (note that while a table of employees is discussed throughout, any particular type of table (SQL, EXCEL, and so forth) relating to any particular type of data may be used in accordance with the principles described herein).

Furthermore, in order to display the underlying data/data fields flowing through the transformation graph in the most intuitive/meaningful way, the computer system 100 may identify underlying data as being associated with a data type 234 (e.g., strings of text for first names, dates of birthdays, images/photos of employees, numbers for salaries, and so forth). Data type 234 may further include both a determination of a general data type 336 and a specific data type 338 for any given underlying data (e.g. a chosen field of a data set/data table). For example, the generic data type for a salary may be a number, integer, or floating point, while the specific data type may be a salary, a currency, an age, and so forth.

Accordingly, the computer system may include a hierarchical way of representing these data types. As such, the number of cards that is suitable for a numbers data type may be a set (i.e., multiple possible cards) and the number of cards that may be suitable for a currencies data type is a subset (i.e., another set of multiple possible cards within the first set) of the number of cards suitable for the numbers data type (even smaller subsets of cards may then be included within currencies, including salaries, gross domestic product, revenue, and so forth).

The shape of the data set may also include any metadata relating to the data set. For example, such metadata may include metadata relating to particular data/fields within the data set, such as minimum length, maximum length, the particular alphabet for encoding values, maximum/minimum value for numbers, required data vs. not required (i.e., when a row or any other data is modified, a particular field may be required to remain regardless). For example, a card for a required piece of data of a particular data set may visually emphasize that there is an important piece of data included in the particular field (e.g., animation, flashing, bigger text than default text, bigger visualization than a default size and so forth).

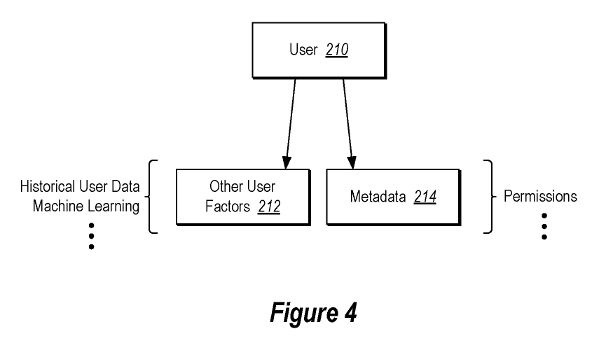

As shown in FIGS. 2 and 4, computer system 100 may also consider user-specific data 210 as a factor in determining the most suitable visualization for presenting given data. As shown, user-specific data 210 may include metadata 214 associated with a particular user or group of users, as well as other user factors 212 (e.g., historical user data, machine learning, and so forth, as described further herein). In some embodiments, the user may be the author of the generated application during foundational application runtime (i.e., during the authoring of the generated application). In other embodiments, the user may be an individual using the generated application during generated application runtime (i.e., after the generated application has been published).

As shown in FIG. 4, user-specific data may comprise metadata relating to a specific user (or group of users), including permissions of the user. For example, with respect to users during foundational application runtime (i.e., authors), permissions may comprise whether the user (author) has permission to use a particular data table/data set, change data within a data table/data set, add data to a data table/data set, delete data from a data table/data set, sort a particular data set (or portions thereof), filter a particular data set (or portions thereof), filter in particular ways, change cards/visualizations with respect to a data set, and so forth. Such permissions may be granted to an author/user based on any applicable criteria. For example, permissions may be determined on a per user/author basis by the foundational application, the owner(s) of the underlying data sets, the computer system, or any other applicable entity.

Similarly, with respect to users during the generated application runtime, permissions may comprise whether the user has permission to use a particular data table/data set, change data within a data table/data set, add data to a data table/data set, delete data from a data table/data set, sort a particular data set (or portions thereof), filter a particular data set (or portions thereof), filter in particular ways, and so forth. Once again, such permissions may be granted to an end user based on any applicable criteria. For example, the permissions may be assigned on a per user basis by the author of the generated application, the foundational application, the computer system, the owner(s) of the underlying data sets, or any other applicable entity.

Furthermore, regardless of whether an applicable user is interacting with computer system 100 during the foundational application runtime or during the generated application runtime, permissions may be granted to the user based on a title, position, or group of the user. For example, an end user of a generated application that is a human resources (“HR”) director of a company may be granted permissions to perform more operations/modifications to either the underlying data or the generated application than an ordinary employee of the same company.

The computer system 100 may also make use of the HR director's permissions to determine the most suitable card for representing the underlying data to the HR director. In a more specific example, assuming the end users are interacting with the generated application during generated application runtime, permissions for salary may be read-only for the ordinary employee, while being read/write for the HR director (i.e., the HR director may be able to edit salaries, while the ordinary employee may not). Accordingly, with respect to a determined card for salaries, the ordinary employee may be presented with an un-editable label or an un-editable slider presenting the applicable salary. On the other hand, the determined card for salaries presented to the HR director may include an editable text box, an editable slider, and so forth. Thus, the most suitable card to represent the same underlying data may be different for each end user (or author during foundational application runtime) based on permissions (e.g., different for the HR director vs. an ordinary employee).

FIGS. 2 and 4 also include other user factors 212 that may be used by computer system 100 to determine the most suitable card type for a given data set, including historical data and machine learning. For example, the computer system 100 may consider how an end user has historically interacted with data of a particular type, which cards the end user has chosen to represent a specific data type, and so forth. For example, a user may have consistently changed salary data type visualizations into sliders, regardless of what was originally determined by the computer system 100 to be the most suitable/intuitive card (e.g., text box, label, and so forth). Similarly, the computer system may use machine learning to continue to improve the selection of suitable cards. For example, the computer system may determine the most suitable card type for a given data set based on what card most users have chosen to visualize the particular data set.

While the computer system may analyze all of the factors discussed herein in connection with selecting the most intuitive/suitable card type for a particular data set, the computer system may limit the analysis to any combination of one or more of the described factors, as well. In this way, the computer system may use data types, metadata associated with a data set, metadata associated with a user, other user factors, and/or card types to determine the most suitable visualizations for presenting data within a generated application.

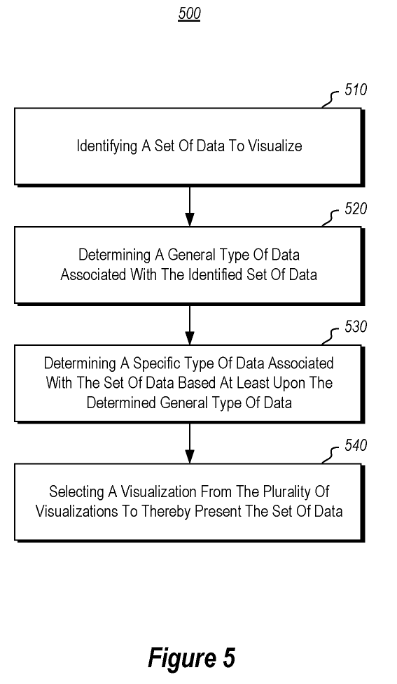

FIG. 5 illustrates a flowchart of a method 500 for selecting a visualization for displaying data of a particular data type. The method 500 includes identifying a set of data to visualize (Act 510). For example, a data set associated with an employee may be identified. Once the set of data has been identified, a general type of data associated with the identified set of data is determined (Act 520). For instance, the data set associated with the employee may include data regarding the employee's age (e.g., the general data type may be an integer), the employee's salary (e.g., integer type or floating point type), the employee's title (e.g., string type), and so forth. The method 500 further includes determining a specific type of data associated with the set of data based at least upon the determined general type of data (Act 530). For instance, the employee's salary may be determined to be of a floating point type (i.e., general data type) and a salary type (i.e., specific data type).

Determining the specific type of data may also comprise identifying a plurality of visualizations associated with the specific type of data. For example, a plurality of visualizations may correspond to floating point data types, and a subset of the plurality of visualizations may correspond to salary data types, all of which may be identified. The method 500 further includes selecting a visualization from the plurality of visualizations to thereby present the set of data (Act 540). For instance, one of the subset of the plurality of visualizations associated with salary data types may be selected. As described herein, user-specific data associated with an author or user of an application (i.e., the application displaying the visualization(s)) may also be considered when selecting the most suitable visualization. For example, a user's permissions, historical use, title, and so forth may be used in the visualization selection.

Such a process for selecting a suitable card for a particular data set may thus be performed repeatedly until all of the underlying data points are presented using the most suitable cards (i.e., the visualizations/cards that are most intuitive to an author/end user, the most consumable by an author/end user, and/or the visualizations that an author/end user has most consistently used for a particular data type). Furthermore, authors of a generated application may be able to make edits to initially selected cards before publishing the generated application (i.e., during foundational application runtime), while end users of a generated application may not be able to edit initially selected cards after the generated application has been published (i.e., during generated application runtime).

In this way, the most suitable visualizations may be displayed based on a determined general and specific data type. User-specific data may also be utilized to display the most intuitive visualization for a particular data set. Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more processors; and
one or more computer readable storage media having stored thereon computer-executable instructions that are executable by the one or more processors to cause the computer system to select a visualization for displaying data of a particular data type, the computer-executable instructions including instructions that are executable to cause the computer system to perform at least the following:
identify a set of data to visualize;
determine a general type of data associated with the identified set of data;
determine a specific type of data associated with the set of data based at least upon the determined general type of data, wherein determining the specific type of data also comprises identifying a plurality of visualizations associated with the specific type of data; and
select a visualization from the plurality of visualizations to thereby present the set of data.

2. The computer system of claim 1, wherein the specific type of data comprises a subset of the general type of data.

3. The computer system of claim 2, wherein the general data type comprises a floating point type and the specific data type comprises at least one of a salary type, revenue type, age type, and currency type.

4. The computer system of claim 1, wherein the selection of a visualization occurs during authoring of an application.

5. The computer system of claim 1, wherein the selection of a visualization occurs after a generated application has already been published.

6. The computer system of claim 5, wherein data associated with a particular user of the published application is also considered in the selection of a visualization.

7. The computer system of claim 6, wherein data associated with the particular user of the published application comprises one or more permissions associated with the user.

8. The computer system of claim 7, wherein the one or more permissions are assigned by one or more authors of the generated application.

9. The computer system of claim 1, wherein metadata associated with the set of data is also considered in the selection of a visualization.

10. A method, implemented at a computer system that includes one or more processors, for selecting a visualization for displaying data of a particular data type, the method comprising:
identifying a set of data to visualize;
determining a general type of data associated with the identified set of data;
determining a specific type of data associated with the set of data based at least upon the determined general type of data, wherein determining the specific type of data also comprises identifying a plurality of visualizations associated with the specific type of data; and
selecting a visualization from the plurality of visualizations to thereby present the set of data.

11. The method of claim 10, wherein the specific type of data comprises a subset of the general type of data.

12. The method of claim 10, wherein the selection of a visualization occurs during authoring of an application.

13. The method of claim 12, wherein data associated with an author of the application is also considered in the selection of a visualization.

14. The computer system of claim 13, wherein data associated with the author of the application comprises one or more permissions associated with the author.

15. The method of claim 10, wherein the selection of a visualization occurs after a generated application has already been published.

16. The method of claim 15, wherein data associated with a particular user of the published application is also considered in the selection of a visualization.

17. The method of claim 16, wherein data associated with the particular user of the published application comprises historical data that includes information regarding the particular user's interactions with data of at least one of the determined general data type and the specific data type.

18. The method of claim 16, wherein data associated with the particular user of the published application comprises one or more permissions associated with the particular user.

19. The method of claim 18, wherein the one or more permissions are assigned by one or more authors of the generated application.

20. A method, implemented at a computer system that includes one or more processors, for selecting a visualization for displaying data of a particular data type during use of a published application, the method comprising:
identifying a set of data to visualize;
determining a general type of data associated with the identified set of data;
determining a specific type of data associated with the set of data based at least upon the determined general type of data;
identifying one or more data items associated with a user of the published application; and
based on at least the general data type, the specific data type, and the user-specific data, selecting a visualization from a plurality of visualizations to thereby present the set of data.
